(19) United States
(12) Patent Application Publication
(10) Pub. No.: US 2015/0206208 A1
(43) Pub. Date: Jul. 23, 2015

(54) Method and System for Charging and Fee Sharing According to Network Video Playing Amount

(71) Applicant: 1Verge Internet Technology (Beijing) Co., Ltd., Beijing (CN)

(72) Inventors: Shujie Sun, Beijing (CN); Jian Yao, Beijing (CN); Baiyu Pan, Dongfang City (CN); Shuqi Lu, Beijing (CN)

(73) Assignee: 1Verge Internet Technology (Beijing) Co., Ltd., Haidian District, Beijing (CN)

(21) Appl. No.: 14/420,885

(22) PCT Filed: Aug. 30, 2013
(86) PCT No.: PCT/CN2013/082636

§ 371 Date: Feb. 10, 2015

(30) Foreign Application Priority Data
Sep. 29, 2012 (CN) 201210372127.7

(51) Int. Cl. G06Q 30/04; H04L 29/06

(52) U.S. Cl. CPC G06Q 30/04; H04L 65/4069

(57) ABSTRACT

Described herein is a method and system for charging and fee sharing based on an actual playing amount of network videos. In this system, an order statistic unit stores a number of monthly orders, a corresponding monthly order fee, starting and ending time of each monthly order, a channel fee sharing unit stores a channel fee value or ratio, a network video player plays network videos using an RTMP (real time messaging protocol) of streaming media technology, a traffic recording unit records the playing amount of each network video content provider's programs and a total playing amount of all network videos, and a charging unit obtains data stored in the order statistic unit, the channel fee sharing unit and the traffic recording unit to calculate the fee to be shared with each network video content provider. The charging system according to the invention not only reduces the calculation complexity, but also enhances the system scalability, providing a simple and reliable way for large-volume data transmission.

### FIELD OF THE INVENTION

The present invention generally relates to the field of playing network videos via streaming media technologies, and more particularly, to a method and system for charging and fee sharing based on the actual playing amounts of network videos.

### BACKGROUND

As more and more blockbuster movies are rapidly imported into China, the existing SVOD (Subscription Video On Demand) fee sharing methods commonly adopted by those top copyrighted content providers have become increasingly unsuitable to meet the needs in the local Chinese market. Meanwhile, most domestic network video providers are still in their infancy in terms of exploring different types of fee sharing methods. The SVOD fee sharing mode used by those main network video content providers is so simplex that fees are not calculated in accordance with the actual network video playing amount. Besides, there are a few common technical issues with current technological solutions, which makes the system very complex and unable to scale.

The above-stated problems can be solved by embodiments of the present invention that provide a method and system for charging and fee sharing based on the actual network video playing amounts. Embodiments of the present invention not only significantly reduce the calculation complexity of the charging system, but also enhance the system scalability, providing a simple and reliable system capable of large-volume data transmissions.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One objective of the present invention is to provide a method and system for charging and fee sharing based on the actual playing amounts of network videos. To that end, one embodiment of the invention provides a system for charging and fee sharing based on the actual amounts of network video play, which comprises: an order statistic unit for storing a number of monthly orders, a corresponding monthly order fee and starting time, ending time of each monthly order; a channel fee sharing unit for storing a channel fee value or ratio; a network video player for playing network video by using an RTMP (real-time messaging protocol) of streaming media technology; a traffic recording unit for recording a playing amount of each network video content provider's programs and a total playing amount of all network videos; a charging unit for retrieving data stored in the order statistic unit, the channel fee sharing unit and the traffic recording unit to calculate fees to share with each network video content provider.

In one embodiment, the charging unit in the system obtains data in a standard HTTP manner via standard interfaces.

In one embodiment, the data to be retrieved by the charging unit is digitally signed, wherein the data to be signed is assembled into strings through the following steps: assigning the data to be signed with different parameters, sorting the parameters in an ascending order according to the parameter names, and if there are duplicate parameter names, sorting the parameters in an ascending order according to parameter values, and connecting the sorted parameters with a particular character. The charging unit assigns random strings to each of the order statistic unit, the channel fee sharing unit and the traffic recording unit as a signature key. Digital signatures are obtained through the MD5 message-digest algorithm to form page data. Thereafter, the order statistic unit, the channel fee sharing units and the traffic recording unit each transmit their page data to the charging unit.

In one embodiment, after receiving a page request, the charging unit obtains various parameters in the page data to calculate via the MD5 message-digest algorithm and signature key, and compares the calculated results to determine whether they are identical, and if so, the charge unit accepts the page data, otherwise discards the data.

In one embodiment, the charging unit in the system calculates the fee to be shared with a network video content provider in each monthly order according to the following equation: shared fee=(the playing amount of a network video content provider's program/the total playing amount of the network video)×(monthly order fee−channel fee sharing)×(the present month service ratio), wherein the present month service ratio is the number of days from the starting time of the monthly order to the last day in the month divided by the total number of days included in the month.

Another embodiment of the present invention provides a method for charging and fee sharing based on the actual amounts of network video play. Specifically, the method comprises: (1) storing a number of monthly orders, a corresponding monthly order fee and starting time, ending time of each monthly order in an order statistic unit; (2) storing a channel fee value or ratio in a channel fee sharing unit; (3) playing network videos through an RTMP (real-time messaging protocol) of the streaming media technology by a network video player; (4) recording a playing amount of a network video content provider's programs and a total playing amount of the network videos by a traffic recording unit; (5) obtaining data stored in the order statistic unit, the channel fee sharing unit and the traffic recording unit to calculate fees to be shared with each network video content provider by a charging unit.

In one embodiment, the charging unit retrieves data in a standard HTTP manner via standardized interfaces.

In one embodiment, the data to be obtained by the charging unit is digitally signed. The data to be signed is assembled into data strings according to the following steps: assigning the data to be signed with parameters, sorting the data in an ascending order according to parameter names, and if there are duplicate parameter names, sorting the parameters in an ascending order according to parameter values, and connecting the sorted parameters with a particular character. The charging unit assigns random strings to each of the order statistic unit, the channel fee sharing unit and the traffic recording unit as a signature key. Digital signatures are obtained through an MD5 message-digest algorithm to form page data. The order statistic unit, the channel fee sharing unit and the traffic recording unit each transmit the page data to the charging unit.

In one embodiment, after receiving a page request, the charging unit obtains various parameters from the page data to calculate through the MD5 message-digest algorithm and signature key, and compares calculated results to determine if they are identical, and if so, the charging unit accepts the data, otherwise discards the data.

In one embodiment, the charging unit calculates the fee to be shared with a network video content provider in each monthly order according to the following equation: shared fee=(the playing amount of a network video content provider's program/total playing traffic of the network video)×(monthly order fee−channel fee sharing)×(the present month service ratio), wherein the present month service ratio is the number of days from the starting time of the monthly order to the last day in the month divided by the number of days included in the month.

Embodiments of the present invention provide such advantages as reduced calculation complexity of the charging system and enhanced scalability. A simple and reliable system capable of large-volume data transmissions is provided in the present invention.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a schematic diagram showing the traffic of different network video programs according to embodiments of the present invention;

FIG. 2 is a structural schematic diagram of the charging and fee sharing system according to embodiments of the present invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

The traditional way of transmitting multimedia information, such as audio and video and the like, over networks is to play the multimedia content after all the information is completely downloaded. However, the downloading process often takes several minutes to even hours. Through the streaming media technology, streaming transmission can be achieved, with which any sound, image or animation can be continuously and uninterruptedly transmitted from the server to users' computers. As such, users do not have to wait until the entire file is downloaded, and instead, they can view the content almost immediately after or no more than ten seconds of delay after the download is started. In that case, while the multimedia information, such as audio and video and the like, transmitted over networks is played on a user's device, the remaining files is still being downloaded from the server.

The traditional technology has the advantage that once multimedia files such as audio files are downloaded from the server over the network, there is no further storage or power consumption in the server, which can reduce server costs. However, the disadvantage is, because the audio and video files transmitted over the network are buffered in the client device, the data confidentiality is compromised, which can cause copyright protection issues.

The above-stated problem can be effectively solved with a network video player according to embodiments of the present invention, which uses the RTMP (Real Time Messaging Protocol) of streaming media technologies.

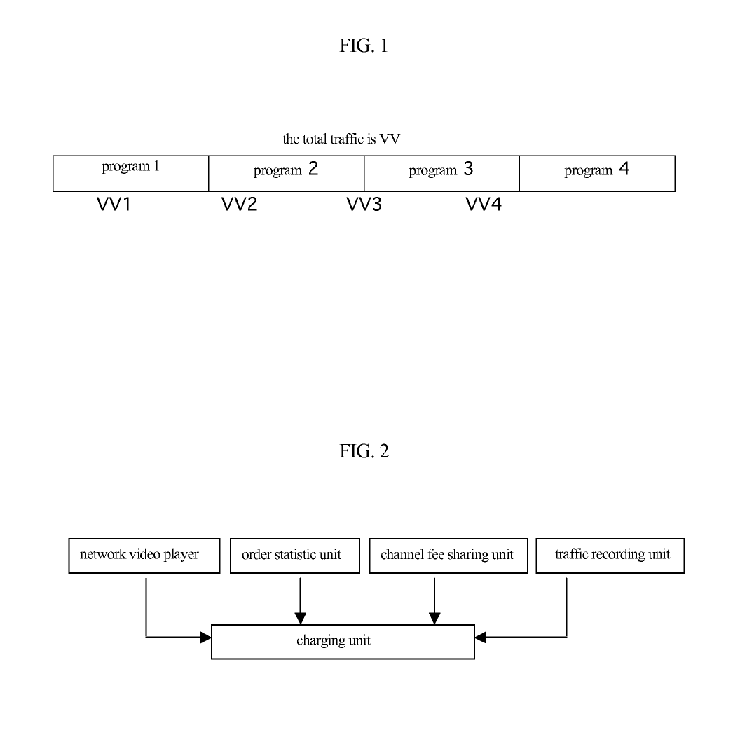

FIG. 1 is a schematic diagram showing the traffic of different network video programs according to embodiments of the present invention.

In the inventive system, the fee to be shared with network video content providers is based on the actual amounts (vv) of network video played and watched by users. Because certain video contents attract more users and can be watched multiple times, the provider of such video contents actually has a higher video-playing amount vv (as the numerator). In that sense, the percentage of this content provider's vv in the total vv of all content providers becomes larger, which means, this particular content provider can receive a higher share of fees. For each monthly order, the system counts which network video programs have been watched by users in the monthly order and the corresponding playing amount, and based on that information, determines the percentages of each program (i.e., each network video content provider) in the total amount of network video play.

Steps for Obtaining Order Statistics

2.1. Most current monthly orders are usually cross-month orders, although, of course, there can be some orders lasting from the first day of the month to the last day, in which case, the service ratio of that month is 1.

2.2. The monetary amount of each monthly order in the settlement month is calculated in proportion to the number of service days of the month, i.e. the service ratio of that month service. The service ratio of each month is the number of days from the starting day of the monthly order to the last day in the month divided by the number of days included in the month.

2.3. For each monthly order, the vv generated in the settlement month is the statistical amount counted by the system.

A system for charging and fee sharing according to the actual network video playing amounts is provided according to embodiments of the present invention.

As shown in FIG. 2, the system includes the following units: an order statistic unit for storing a number of monthly orders, a monthly order fee and an order service date (i.e. starting time and ending time of the monthly order) of each monthly order; a channel fee sharing unit for storing a channel fee value or ratio; a network video player for playing network video information online; a traffic recording unit for recording the playing amount of programs provided by each network video content provider and the total network video playing amount; a charging unit for obtaining the data stored in the order statistic unit, the channel fee sharing unit and the traffic recording unit to calculate the fee to be shared with each network video content provider.

In one embodiment, the network video player plays network videos through an RTMP (real time messaging protocol) of streaming media technology. The charging unit calculates the fee to be shared with each network video content provider in each monthly order according to the following equation:

Shared fee=(the program playing amount of a network video content provider/the total playing traffic of all network videos)×(monthly order fee−channel fee sharing)×(the present month service ratio),

wherein the present month service ratio is the ratio between the number of days from the starting day of the monthly order to the last day in the month and the number of days included in the month.

In operation, the system may need to perform synchronization and data exchange with multiple network video providers. Therefore, the above-described fee-sharing system needs to have standard interface specifications and security policy, which can not only enhance the system scalability, but also protect transaction information from being tampered.

Under the above-described fee-sharing algorithm, the exchange of information between the order statistic unit, the channel fee charging unit, the network video player, the traffic recording unit and the charging unit is implemented via standard interface protocols. In addition, the communication between the system and respective channels, as well as the orders placed from the system to external network video providers, and the like, are all implemented via standard interfaces.

All standard interfaces are constructed in a standard HTTP manner, according to the following format:

http://<host>/v<version

number>/<system>/<action>?param1=value1&param2=value2 . . .

&signtype=1&sign=<sign>

host is the IP address and domain name of the host system;

version number is the current version of the system.

System: two types are supported currently: getway (payment gateway) and paycenter (payment center);

Action: representing which operations the interface will perform specifically, such as creating a new order: neworder;

### Example

http://pay.youku.com/v1/paycenter/neworder?ver=1& . . .

Representing: Youku uses V1 version currently, and a user is creating a new order.

The calls between the order statistic unit, the channel fee charging unit, the network video player, the traffic recording unit and the charging unit are all implemented in the foregoing standard HTTP (GET, PUT) manner.

Based on the basic HTTP (GET, PUT) protocol, a simple and reliable system-level standard protocol for large-volume data transmissions is constructed.

Safety Specifications:

To ensure the safety and reliability of data transmission between each unit within the system, a valid digital signature can be used to effectively avoid human errors in data transmission, thereby enhancing data reliability. The so-called digital signature is to add some redundant data to the data, or to perform some password conversion for the data. Such redundant data or conversion allows the data receiver to confirm the source of data units and data integrity, and protect data from being forged by someone (e.g., the receiver). It is a way to create signatures for electronic data. Digital signatures can be obtained using both the public key system and private key system. Currently, digital signatures using the public key system are more prevalent. Existing digital signature algorithms include RSA, ElGamal, Fiat-Shamir, Guillou-Quisquarter, Schnorr, Ong-Schnorr-Shamir digital signature algorithm, Des/DSA, Elliptic Curve Digital Signature Algorithm. Specifically, the steps for creating digital signatures are as follows:

1. Digital Signature

To ensure data authenticity and integrity during data transmission between each unit within the system, the transmitted data needs to be digitally signed.

After the signature data is received, the signature is verified.

2. Signature Mechanism

Data to be signed (e.g., data transmitted by the order statistic unit, channel fee sharing unit and traffic recording unit):

The data to be signed is assembled into strings in the following manner:

Since there can be one or more data streams transmitted by the order statistic unit, the channel fee sharing unit and the traffic recording unit, each data stream to be signed is assigned with respective parameters, e.g., p1, p2, p3, etc., which are sorted in an ascending order according to parameter name characters, e.g., p1, p2, p3. If there are duplicate parameter names, the duplicate parameters are sorted in an ascending order according to the parameter values.

All the parameters of each unit according to the above-described order are connected using “&.” For example, p1=v1&p2=v2, where in V1 and v2 are parameter values.

Signature Key:

The charging unit assigns random strings to each of the other units (i.e. the order statistic unit, the channel fee sharing units, the traffic recording unit) as signature key. In actual implementations of the order statistic unit, the channel fee sharing units and the traffic recording unit, the signature key is embedded directly in each unit. The signature key is one or more strings pre-assigned by the system, and is mainly used to define a valid unit. For example, a certain unit is defined with a signature key as 123456, which means, this unit has a unique number of 123456, and information transmitted from this unit is valid.

An example (in terms of transmitting parameters to a certain unit) is shown in the following table:

| Step | Description | Example Code |
|---|---|---|
| Step | Parameters | P2=3, p3=2, p1=6 |
| 1 | | |
| Step | Sorting | P1=6 |
| 2 | | P2=3 |
| | | P3=2 |
| Step | Connecting each array of | P1=6&p2=3&p3=2 |
| 3 | parameters in Step 2 by using | |
| | the character “&” | |
| Step | Calculating and obtaining a | P6=hash_hmac(md5, |
| 4 | signature value using the | P1=6&p2=3&p3=2,123456, |
| | MD5 message-digest algorithm | true)=asdfasdfajsj123w34823948 |
| | in connection with signature key | |
| Step | Combined Step 3 and Step 4 to | P1=6&p2=3&p3=2&p6= |
| 5 | form page data | asdfasdfajsj123w34823948 |
| Step | Sending the page data in | Signing is completed |
| 6 | Step 5 to the charging unit | |

After receiving the page data, the charging unit obtains P6 in the page data and various other parameters, calculates P6 once again based on various other parameters in accordance with the foregoing algorithm, and compares whether the two signatures are identical. Identical signatures indicate that the page data is transmitted by the unit (123456) and thus can be accepted. Otherwise the page data is discarded.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A system for charging and fee sharing based on actual playing amounts of network videos, the system comprising:
an order statistic unit for storing a number of monthly orders, and a corresponding monthly order fee, starting time and ending time of each monthly order;
a channel fee sharing unit for storing a channel fee value or ratio;
a network video player for playing network videos through an RTMP (real time messaging protocol) of streaming media technology;
a traffic recording unit for recording a playing amount of each network video content provider's programs and the total playing amount of all network videos;
a charging unit for obtaining data stored in the order statistic unit, the channel fee sharing unit and the traffic recording unit to calculate fees to be shared with each network video content provider.

2. The system according to claim 1, wherein the charging unit obtains data in a standard HTTP manner via standard interfaces.

3. The system according to claim 1, wherein the data to be obtained by the charging unit is digitally signed by assembling the data to be signed into strings through the following steps:
assigning a number of parameters to the data to be signed;
sorting the assigned parameters in an ascending order according to parameter names, and if there are duplicate parameter names, sorting the parameters in an ascending order according to parameter values; and
connecting the sorted parameters with a certain character,
wherein the charging unit assigns random strings to each of the order statistic unit, the channel fee sharing unit and the traffic recording unit as a signature key, and digitally signs the data through the MD5 message-digest algorithm to form page data,
wherein the order statistic unit, the channel fee sharing unit and the traffic recording unit each transmit the page data to the charging unit.

4. The system according to claim 3, wherein, after receiving a page request, the charging unit obtains various parameters from the page data to calculate through the MD5 message-digest algorithm and signature key, and compares calculated results to determine whether to adopt or discard the page data.

5. The system according to claim 1, wherein the charging unit calculates fees to be shared with a network video content provider in each monthly order according to the following equation:
shared fee=(the playing amount of a network video content provider's programs/a total playing amount of all network videos)×(monthly order fee−channel fee sharing)×the present month service ratio,
wherein the present month service ratio is the number of days from the starting time of the monthly order to the last day in the month divided by the number of days included in the month.

6. A method for charging and fee sharing based on actual playing amounts of network videos, the method comprising:
storing a number of monthly orders, and a corresponding monthly order fee and starting time, ending time of each monthly order in an order statistic unit;
storing a channel fee value or ratio in a channel fee sharing unit;
playing network video information via an RTMP (real time messaging protocol) of streaming media technology by a network video player;
recording a playing amount of each network video content provider's programs and a total playing amount of all network videos by a traffic recording unit;
obtaining data stored in the order statistic unit, the channel fee sharing unit and the traffic recording unit to calculate fees to be shared with each network video content provider by a charging unit.

7. The method according to claim 6, wherein the charging unit obtains data in a standard HTTP manner via standard interfaces.

8. The method according to claim 6, further comprising:
digitally signing the data to be obtained by the charging unit by assembling the data to be signed into strings through the following steps:
assigning parameters to the data to be signed,
sorting the parameters in an ascending order according to parameter names, and if there are duplicate parameter names, sorting the parameters in an ascending order according to parameter values, and
connecting the sorted parameters with a certain character,
wherein the charging unit assigns random strings to each of the order statistic unit, the channel fee sharing unit and the traffic recording unit as a signature key, and digitally signs the data through the MD5 message-digest algorithm to form page data, and
wherein the order statistic unit, the channel fee sharing unit and the traffic recording unit each transmit the page data to the charging unit.

9. The method according to claim 8, wherein after receiving a page request, the charging unit obtains various parameters from the page data to calculate through the MD5 message-digest algorithm and signature key, and compares calculated results to determine whether to accept or discard the page data.

10. The method according to claim 6, wherein the charging unit calculates fees to be shared with a network video content provider in each monthly order according to the following equation:
shared fee=(the playing amount of a network video content provider's programs/a total playing amount of all network videos)×(monthly order fee−channel fee sharing)×the present month service ratio,
wherein the present month service ratio is the number of days from the starting time of the monthly order to the last day in the month divided by the number of days included in the month.
